(19) United States
(12) Patent Application Publication
(10) Pub. No.: US 2007/0205325 A1
(43) Pub. Date: Sep. 6, 2007

(54) Separable under load shaft coupling

(75) Inventor: William Martin Waide, Adelanto, CA (US)

Correspondence Address: Rutan & Tucker, LLP.;Hani Z. Sayed, 611 ANTON BLVD, SUITE 1400, COSTA MESA, CA, 92626, US

(73) Assignee: Karem Aircraft, Inc.

(21) Appl. No.: 11/473,979

(22) Filed: Jun. 23, 2006

Related U.S. Application Data
(60) Provisional application No. 60/693,722, filed on Jun. 24, 2005.

(51) Int. Cl. B64D 35/00

(52) U.S. Cl. 244/60

(57) ABSTRACT

Contemplated couplings include an intermediate shaft internal and coaxial to a driver and a driven shaft, wherein the intermediate shaft moves a plurality of teethed rollers that engage with corresponding splined inner surfaces of the driver and the driven shaft. Such devices allow separation of the shafts under load using substantially reduced force and will typically have a friction coefficient virtual μ of less than 0.05.

This application claims the benefit of our U.S. provisional patent application with the serial No. 60/693722, which was filed Jun. 24, 2005.

### FIELD OF THE INVENTION

The field of the invention is drive couplings.

### BACKGROUND OF THE INVENTION

Multi rotor aircraft, and especially tilt rotor aircraft and compound helicopters provide unique capabilities and have become increasingly attractive. However, while various advantages can be realized with such airplanes, tilt rotor aircraft, tilt wing aircraft and compound helicopters with two rotors and two engines cannot continue flight to a safe landing when a rotor (not an engine) fail, especially during hover and conversion to forward flight.

Therefore, most such aircraft employ a cross-wing driveshaft that couples the left rotor to the right rotor to provide backup actuation for hover and VTOL. Moreover, the cross-wing drive shaft can also be used to provide power in forward flight in the event of an engine failure. However, in emergencies where the rotor is the failure point, the driveshaft must be quickly disconnected regardless of the load on the driveshaft. Such quick-disconnect could be implemented as an emergency response, or as part of a fail-operational strategy when parts of the aircraft fail and are inoperable, but the remainder of the aircraft must continue to function. Still further, in order to render tilt-rotor and tilt-wing aircraft acceptable for large scale transportation of passengers, it must be possible to continue flight to a safe landing with a damaged or disabled rotor, and not allow such single-point failure to unduly compromise flight safety.

For these reasons, it is desirable for the functioning rotor to be rapidly disconnected from the disabled rotor, and if necessary, to do this under load. Commonly known clutch methods for a quick disconnect include a range of friction devices, and a range of mechanically-engaged elements such as dog clutches and straight splines. Unfortunately, as the scale of the machinery increases, and the power and torque increase (e.g., to and above several thousand foot pounds), plate clutches become large and heavy. Similarly, sliding elements require very high axial displacing forces at such high torque, usually as a result of friction.

For example, most known plate clutches require either multiple friction surfaces, high clamping loads or a large diameter, or a combination of these features. Any combination carrying high torque is a heavy set of components. Similarly, splines rely on the transfer of tangential forces across a sliding interface and even when friction-reducing techniques are used, a large force is required to induce sliding. Conventional splines are particularly unsuited to being separated when under load because of the constantly rising stress of the remaining portions in engagement and the subsequent yielding and local failure. A further known category of disengageable couplings is the ball detent type of device whereby one or a series of balls or rollers spans the division between the two shafts and are held in place by a movable strut. When the strut is removed, the balls or rollers escape into prepared cavities and the drive is thus disconnected. While such ball detents typically reduce friction to at least some degree, load bearing is typically limited to a single point of contact, and deformation and malfunction, especially at high torque can not be excluded.

Therefore, while there are numerous compositions and methods for separable under-load couplings are known in the art, various difficulties nevertheless remain. Among other things, known devices typically have excessive weight, high displacing loads to separate the drive, and high contact stresses within the drive elements. Thus, there is still a need for improved separable under-load couplings.

### SUMMARY OF THE INVENTION

The present invention is directed to devices and methods for separable under-load couplings in which rotating shafts are alternatively driven or decoupled using a set of circumferentially disposed rollers.

Various objects, features, aspects and advantages of the present invention will become more apparent from the following detailed description of preferred embodiments of the invention.

### BRIEF DESCRIPTION OF THE DRAWING

FIG. 1 in an exemplary tilt rotor plane with separable under-load couplings.

FIG. 2 is a horizontal cross-section of a exemplary coupling that shows the driver and driven shafts, the tangential rollers, the cage for locating the rollers, and the actuator required for axially displacing the roller and cage element.

FIG. 3 is an end view of the coupling of FIG. 2.

FIG. 4 is a perspective view of a portion of the splined surface of the coupling of FIG. 2.

### DETAILED DESCRIPTION

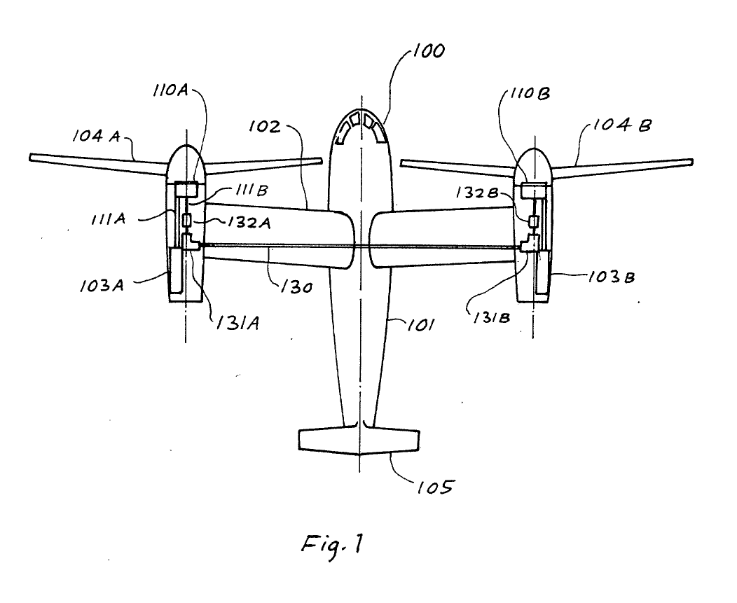

A typical tilt rotor aircraft is depicted in FIG. 1 in which rotorcraft 100 includes fuselage 101, a transverse wing 102, tail 105, left and right engines 103A and 103B, with left and right rotors 104A and 104B, respectively. Left and right gearboxes 110A and 110B are rotatably coupled via cross-wing drive shaft 130, angle drives 131A and 131B, and separable under-load couplings 132A and 132B. Shafts 111A and 111B transmit power from the engines to the rotors.

In rotorcraft or fixed wing aircraft with more than one rotor or propeller, continued flight is often possible with a single rotor. But, unless there are multiple power sources, it is necessary to disable and disconnect the damaged rotor or propeller from the power source. And it is necessary to do that quickly, and under load. Couplings as contemplated herein can be used for that purpose. In especially preferred embodiments, significant torque capacity can be achieved by utilizing many rollers, with each roller having a relatively large contact area. The relatively large contact area of each roller can be achieved by the contact geometry between the tooth form the roller and the contact splines. Especially preferred tooth forms are of the involute form. Contact area can be further multiplied by utilizing multiple rows of the rollers described above, wherein each of the rollers will have multiple teeth that correspond to multiple splines. Rollers are preferably held in position by a connecting cage.

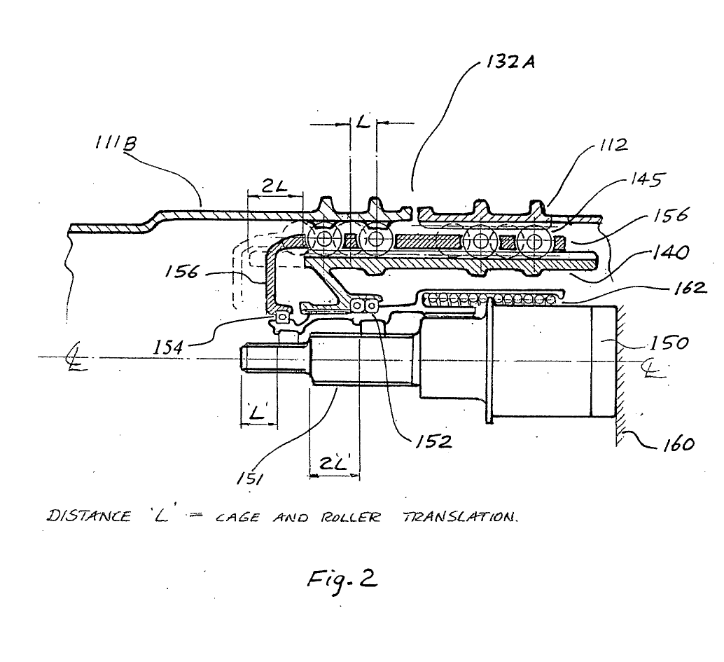

FIG. 2 depicts an exemplary configuration of a coupling 132A comprising a hollow driver 111B and a hollow driven shaft 112, and a third, co-axial shaft 140 located internal to both driver and driven shafts. Tangential rollers 145 are in mutual contact with the internal surfaces of the driver 111B and driven shafts 112, and the external surface of the intermediate shaft 140. When the intermediate shaft 140 is moved axially relative to both outer shafts, the rollers 145 translate by half the amount of the intermediate shaft movement. At the end of travel, the rollers exit the splined length of one shaft, become disengaged, and occupy free space in an annular groove, whereby the drive is disconnected. The rollers 145 remain in engagement with the splines in the driven shaft 112. Typically, the rollers are kept in alignment by means of a cage 156.

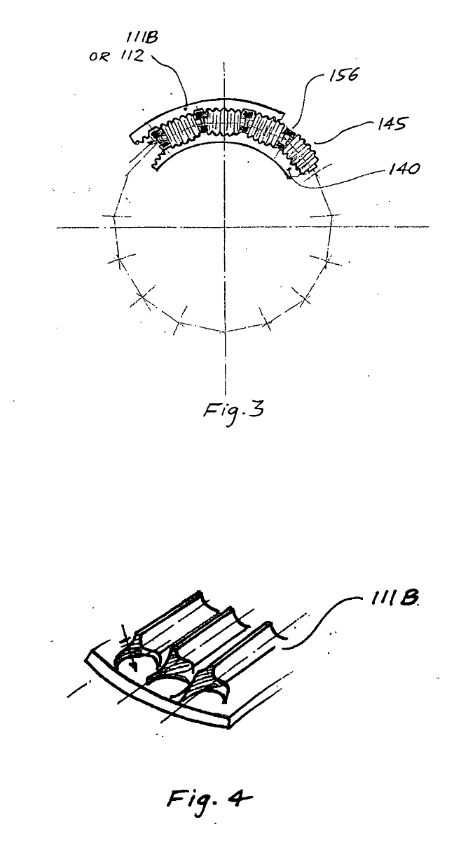

A disengagement force can be provided by any suitable mechanism, including for example, an electric actuator 150 with linear output 151, as shown. A convenient location for the actuator is internal to and co-axial with the hollow shafts. Thrust bearings 152 and 154 are arranged to connect both the inner shaft 140 and the roller cage 156 to the actuator, which can then be mounted on non-rotating structure 160. The actuator can be constructed with a dual output, whereby the distance traveled by one output is twice the distance traveled by the other. Most preferably, the actuator is centered to the engaged position by spring 162. Thus, the intermediate shaft is moved twice the distance of the cage and rollers, which is the position relationship required for correct phasing of rollers and roller cage. FIG. 3 is an axial view of a section of hollow driver shaft 111B (or a section of driven shaft 112) with coaxial connector shaft 140. Tangential rollers 145 are guided by cage 156. FIG. 4 is an isometric sketch of the termination feature of internal splines in shaft 111B. A spherical indentation (arrow) centered on a spline space (or groove) facilitates entry of rollers 145 (not shown).

Among other benefits of contemplated devices and methods, it should be appreciated that relatively low displacing forces can be used to displace the drive connection when transmitting substantial torque. A typical value of the displacing force is 2,000 pounds for a 10,000 horsepower drive. In such an embodiment one might well utilize 60 rollers in a device of approximately 12 inches in diameter, wherein the rollers could advantageously have a diameter on the order of about 0.8 inches. Viewed from a different perspective, heretofore known devices using lubricated steel-on-steel sliding contacts will have a virtual μ (coefficient of friction) of at least 0.1, whereas the rolling contacts according to the inventive subject matter will have a virtual μ of less than 0.05, more typically less than 0.02, and in some cases even less than 0.01. The rollers will preferably comprise a high-strength material, most typically a hardened steel (e.g., carbon stee, carbon-chromium steel, etc.), a steel or other metal (e.g., titanium) alloy, or other materials, including hafnium carbide, and boron carbide.

It should still further be appreciated that due to the relatively high number of rollers in contemplated devices, the device is readily re-engageable at small angle increments. Moreover, it should be noted that roller preload is possible in such devices , which advantageously avoids or at least reduces backlash and the adverse effects of clearance, such as fretting, brenelling, wear, etc.

There is additional consideration of a voluntary, i.e. anticipated and conducted under conditions of control, disconnection of all elements of the cross-wing mechanism, which would include all connecting gearboxes and all shaft elements. This would have a useful mechanical loss reduction, life enhancement and noise reduction, and would require a coupling re-engagement feature to be added. This would be the same disconnect-under-load device but arranged to be re-connected (synchronized) at the time of a threat identification. It would also be re-connected if sensor indications suggest impending engine failure. As a control possibility, the disconnection could occur simultaneously with the shift to low propeller speed airplane mode because this, by definition, is a low-power condition with excess energy of rotation requiring a power reduction.

Thus, specific embodiments and applications of separable under load couplings have been disclosed. ft should be apparent, however, to those skilled in the art that many more modifications besides those already described are possible without departing from the inventive concepts herein. The inventive subject matter, therefore, is not to be restricted except in the spirit the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A coupling that couples a first shaft having a first set of internal teeth and a second shaft having a second set of internal teeth, the coupling comprising:
an intermediate member internal to, and concentric with the first and second shafts;
a plurality of rollers circumferentially disposed about the intermediate member, each of the plurality of rollers having an axis of rotation that is tangential to a surface of the intermediate member, and the plurality of rollers sized and dimensioned to fit between the first and second sets of teeth; and
a roller cage configured to align the plurality of rollers relative to the intermediate member.

2. The coupling of claim 1, further comprising an actuator that is configured to translate the intermediate member, rollers, and roller cage along a long axis of the coupling.

3. The coupling of claim I, wherein the first set of teeth has an involute form.

4. The coupling of claim 3, wherein the plurality of rollers are in conformal contact with the involute form of the first set of teeth.

5. The coupling of claim 3, wherein the second set of teeth have the involute form, and the plurality of rollers are in conformal contact with the involute form of both the first and second sets of teeth.

6. The coupling of claim 3, wherein the involute form provides greater than point contacts between individual ones of the first set of teeth and individual ones of the plurality of rollers.

7. The coupling of claim 1, having a coefficient of friction, virtual μ, less than 0.05.

8. The coupling of claim 1, having a coefficient of friction, virtual μ, less than 0.02.

9. The coupling of claim 1, wherein the plurality of rollers comprise hardened steel.

10. An aircraft having first and second engines that provide power to a rotor via first and second drive trains, respectively, through an interconnection system, and a coupling according to claim 1 disposed in the first drive train that allows de-coupling of the rotor from the interconnection system.
